(19) United States
(12) Patent Application Publication
(10) Pub. No.: US 2025/0069826 A1
(43) Pub. Date: Feb. 27, 2025

(54) LAMINATION ARRANGEMENT FOR THE LAMINATING OF A SWITCH IN A VEHICLE

(71) Applicant: Lisa Dräxlmaier GmbH, Vilsbiburg (DE)

(72) Inventors: Franz SCHAITL, Gangkofen (DE); Martin FEINEIS, Landshut (DE); Josef KIERMAIER, Unterdietfurt (DE); Andreas HERB, Gauting (DE)

(73) Assignee: Lisa Dräxlmaier GmbH, Vilsbiburg (DE)

(21) Appl. No.: 18/811,055

(22) Filed: Aug. 21, 2024

(30) Foreign Application Priority Data
Aug. 22, 2023 (DE) 10 2023 122 415.8

(51) Int. Cl. H01H 13/04

(52) U.S. Cl. CPC H01H 13/04; H01H 2209/014; H01H 2209/016; H01H 2231/026

(57) ABSTRACT

A lamination arrangement for laminating a switch in a vehicle including at least one first layer that with one surface forms a visible side of the lamination arrangement, and at least one second layer. The at least one second layer is disposed opposite the visible side and at least partially under the first layer. The first and second layers are elastically deformable such that the actuation of at least one switch is made possible by exertion of force on the visible side. The at least one switch is disposed under the second layer.

### CROSS-REFERENCE TO RELATED APPLICATIONS

This application claims priority to and the benefit of DE 10 2023 122 415.8 filed on Aug. 22, 2023. The disclosure of the above referenced application is incorporated herein by reference.

### FIELD

The present disclosure relates to a lamination arrangement for the laminating of a switch in a vehicle.

### BACKGROUND

The statements in this section merely provide background information related to the present disclosure and may not constitute prior art.

Vehicles, in particular motor vehicles, but also ships or airplanes, often include components with operating elements for the controlling of certain functions, such as, for example, the heating, the lighting, or the climate system. Here the setting of the functions is undertaken in large part via corresponding switches or buttons. A certain function, for example, a vehicle interior lighting, can thus be activated or deactivated by a user at the press of a button via the corresponding switch. These switches are often attached onto laminated or decorative surfaces of the components.

Such switches are usually provided as separate elements. This results in that the laminated or decorative surfaces in the region in which, for example, the electronic or mechanical components of the switch are disposed is disadvantageously interrupted. Thus, conventional switches usually protrude out over the surface of a component.

In newer vehicles it is often desired to obtain a flat-as-possible and uninterrupted laminated/decorative surface of a component. When such a component is to be provided with switches, to date switches based on electroactive polymers, capacitive films, or optical systems are used, which can terminate relatively flush with a component surface. However, such switches are also commonly provided as separate elements in a surface of the component, whereby a laminated/decorative surface is disadvantageously interrupted. In addition, such switches per se cannot deliver any haptic feedback to the user via the switching operation, and also cannot define any triggering force. For this purpose in the prior art additional, expensive driven actuators, signal- and control-devices must be provided.

### SUMMARY

This section provides a general summary of the disclosure and is not a comprehensive disclosure of its full scope or all of its features.

The present disclosure provides an improved integration of a switch in a vehicle and corresponding components.

The present disclosure relates to a lamination arrangement for the laminating of a switch in a vehicle, including at least one first layer that with its surface forms a visible layer of the lamination arrangement, at least one second layer, which is disposed opposite the visible layer at least partially under the first layer, in which the first and second layer are elastically deformable such that by exertion of force on the visible side, the actuation is made possible of at least one switch that can be disposed at least partially under the second layer.

The present disclosure further relates to a switch assembly including such a lamination arrangement. The present disclosure further relates to a manufacturing of a lamination arrangement for the laminating of a switch in a vehicle. The present disclosure further relates to a vehicle component comprising a corresponding lamination arrangement or switch arrangement.

Thus due to the lamination arrangement, a switch provided under the lamination arrangement can simply and cost-effectively be completely hidden under the layer construction, wherein simultaneously the full functionality of the covered switch is provided. The lamination arrangement can also make possible the use of simple and cost-effective (electro-) mechanical switches that can reproduce a suitable haptic or acoustic feedback for a user via the switching operation, or can also define a certain actuating force.

In the present case, “lamination” is understood very generally to mean the cladding or covering of an outer surface, for example, of a vehicle component. A “lamination arrangement” is correspondingly understood to mean a layer arrangement or a layer construction that is in principle suited to at least partially clad or cover a surface of a component. Visible surfaces of a component can thus be laminated with the first and second layer, i.e., clad or covered. Functional components or elements such as switches can thus advantageously be hidden under the laminated surface. A switch disposed under the lamination arrangement can advantageously thus be effectively protected from damaging influences such as moisture or dirt. Here in principle any type of switch can be suitably laminated, for example, switches that work with a mechanical, electrical, optical, or capacitive mechanism or a combination thereof.

The lamination arrangement is suited in particular, but not exclusively, for use in the automotive sector, for example, as decoration or part of a decoration in an interior of a vehicle, for example, as cladding for a start/stop switch, as instrument panel, central console, door cladding or the like, in particular of an automobile and/or of a truck.

Here the lamination arrangement can be at least partially fixedly connected with the surface of an underlying component. The lamination arrangement can also comprise more than one first layer and more than one second layer.

The first layer can be a decorative layer that provides a decorative surface. This layer can be formed, for example, from one or more suitable materials, such as, for example, leather, artificial leather, textile, or plastic, and have a desired surface structure, for example, smooth or contoured. The first layer can also simultaneously or alternatively at least partially define a protective layer, and comprise a material that is suited to protect the underlying layers and the component from external influences, such as, for example, water or contamination.

The second layer can be a functional or carrier layer and provide, for example, a suitable adhesion with the first layer disposed over the second layer, and/or the surface, provided under the second layer, of a component. The second layer can be formed, for example, from one or more suitable materials, such as, for example, plastic or elastomers (e.g., TPE, silicone, EPDM, PU).

The first and second layer should have a suitable deformability. For example, the layers can be deformable such that a user can deform them with common manual physical effort, for example, with a press on the visible layer with one or more fingers, and deflect them toward a switch disposed under the lamination arrangement. Here the materials used are, in one example, configured elastically deformable such that after the completion of the press-in process, the layers again return completely into their initial position. A force exertion can be affected perpendicular, i.e., in the direction normal to the visible surface, or also at any angle to the normal direction, i.e., for example, obliquely from above onto the visible side. Accordingly the elastic deformability of the first and second layer of the lamination arrangement can be adapted to the type of the switch used and the exertion of force occurring.

In the present case, “visible side” is understood to be the side or surface that represents an outermost layer of a component, i.e., can usually be seen by a user. For example, the surfaces, visible to a user, of consoles, or the surface of the door of a glove compartment can represent corresponding visible sides in the vehicle interior. Accordingly, outside the vehicle the surface of a door handle, gas cap, charging cap, or of a trunk lid can represent corresponding visible sides.

The visible side can define, for example, a continuous decorative surface. Here the switch can be completely hidden under the lamination arrangement. The visible side can thus define an uninterrupted surface, which makes possible a “seamless” integration of an underlying switch. This can bring about, in addition to a visual improvement of the corresponding laminated component, an improved protection of the underlying switch from dirt and moisture. The continuous surface can thus also be better able to be cleaned, since no gaps or interruptions are present in the surface. The installation of the switch or of the component in the vehicle can thus also be simplified.

In the present case an “actuation of a switch” is understood to be a standard operating principle, i.e., for example, that the switch can be brought from a first state into at least one different second state. Here each state can correspond to one or more of the functions controlled by the switch. For example, via an activating or deactivating of a switch, a locking or unlocking of a lock and/or the activating or deactivating of an electric circuit can be affected. After the completion of the actuation, the switch can return into its initial position, or it can persist in the second state until it is actuated again.

In one example the first layer and/or the second layer includes at least one switch region, wherein the deformability of the first layer and/or the second layer within the switch region is at least partially greater than outside the switch region.

The switch region can be a spatially, for example, flatly, extending region essentially in the direction of extension of the first and second layer. Here the switch region can be disposed at least partially above the switch. With a point of view from outside onto the visible side, the switch region can define, for example, a surface region on the lamination arrangement in which a user can, in one example, actuate an underlying switch. Thus, for example, when a user presses-in a region of the visible side outside of the switch region, no actuation of the switch disposed under the lamination arrangement is affected.

Due to an increased deformability, an actuation of the switch can be made possible even with low exertion of force by a user. Thus with the same exertion of force a user can press-in the lamination arrangement more deeply in the switch region than outside the switch region. Thus a user can receive a haptic feedback in which region of the lamination arrangement a switch is provided.

However, the switch region can also, at least partially, have a reduced deformability. Thus the switch region can have areas that are configured relatively rigid in order to act on an underlying mechanical component of a switch. This can be affected, for example, by the providing of reinforcements or bridges in the second layer. Thus due to the partially more rigid design in these regions, a direct force transmission onto the underlying switch can be made possible.

The switch region can include haptic or visual means, for example, for the indicating of the switch region. Haptic means can be felt by a user, and, for example, comprise one or more stampings, other surface condition such as texturing or elevations or recesses, or a morphing surface that are disposed on the visible side of the first layer. Visual means can comprise, for example, illuminable regions in the first layer or second layer, in which the regions are designed such that they can be shined-through by corresponding light sources, such as, for example, LEDs, that are disposed opposite the visible layer under the first layer. This can be achieved, for example, via transparent regions, such as perforations or microperforations, that can be at least partially filled in with a material that is at least partially transparent in visible wavelengths. The transparent material can be, for example, an injected two-component material. In this manner, any type of illuminable, through-lightable, or backlightable pattern or symbol can be provided on the visible side of the lamination arrangement. For example, the switch can be configured to be illuminated such that a display of a switch status of the function controlled by it, for example, active or inactive, can be shown. In a further example, the pattern or symbol can also be shown on the visible side by projection.

In one example the layer thickness of the first layer and/or the second layer is at least partially smaller in the switch region than outside of the switch region.

This can make possible an adapting of the deformability of the first and second layer. Thus, for example, a displacement of the first and second layer toward the switch disposed thereunder can be adapted to. Accordingly a switch region can be suitably adapted to the underlying switch used. For example, the deformability of the switch region can be increased without different materials having to be used in the first switch or the second switch. This can simplify the manufacturing of the lamination arrangement.

The first layer here can have a layer thickness of 0.1 mm to 10 mm, in one example, of 0.3 to 4 mm, and in one example of 1 mm to 1.5 mm. The second layer here can have a layer thickness of 0.25 mm to 10 mm, in one example of 1 mm to 5 mm, and in one example of 2 mm to 3 mm. The layer thicknesses here can be essentially constant in the direction of extension, or can be variable. For example, the layer thickness of the second layer can be smaller at an edge region of the switch region, in order to provide an increased deformability and simultaneously be heightened in a central region of the switch region in order to make possible a direct force transmission onto an underlying switch.

In one example, the first layer and/or the second layer includes at least one opening in the switch region and/or is formed from a material that is different from the material of the first layer and/or of the second layer outside the switch region.

The providing of one or more openings permits an adapting of the deformability of the lamination arrangement, without, for example, different materials having to be provided for the first or second layer. This can simplify a manufacturing of the lamination arrangement. An opening can be formed, for example, as a perforation, such as, for example, slot, penetrating the entire layer, or also as an only partial opening or indentation. Here the opening can have any suitable shape or geometry. For example, a plurality of openings can be disposed around a center of the switch region in a spiral- or spoke-pattern. The openings can be configured suitably small in the second layer so that they do not stand out on the surface of the first layer. Viewed from outside, for a user it would not be readily recognizable whether and where corresponding openings are provided.

In a further example, the openings can be formed such that they deliberately stand out on the surface and thus act as tactile aid for the user.

In one example a carrier for receiving the switch is disposed on the second layer.

In the present case, any suitable device that can support and carry a switch is understood as “carrier.” A switch or further means can thus be held on the lamination arrangement in a suitable manner. The carrier can be arranged, for example, to carry further mechanical or electronic components, such as, for example, light sources or a circuit board for the controlling of the switch and of the light sources. Additional light guides can optionally also be provided over the light sources, in order, for example, to better control a light distribution. For example, the carrier can be configured in the form of a housing that at least partially encloses a switch. The carrier can be removably or, however, also fixedly attached to the second layer, or also at least partially integrated into the second layer. Thus a carrier can be disposed at least partially in an opening of the second layer. Here the carrier can be formed from a different material to the first and second layer, or an identical material. For example, the carrier can be formed from a suitably rigid material, such as, for example, plastic or metal.

The present disclosure additionally relates to a switch assembly including the lamination arrangement according to one of the preceding examples and a switch, in which the switch is laminated by the lamination arrangement and is disposed relative to the lamination arrangement such that it can be actuated by exertion of force on the visible side.

In the present case, a switch is understood to be any suitable device with which a user can control one or more functions by, in one example, a manual exertion of force, for example, by the push of a button by one or more fingers. Thus, for example, certain functions in a vehicle can be activated or deactivated by a switch. The switch can be, for example, a microswitch or button. By an actuating of a switch, for example, vehicle components such as a glove compartment, a door, or a trunk lid of a vehicle can be locked or unlocked. Electrical functions such as the switching-on and -off of a seat heating or the starting and stopping of a motor can be controlled via the switch. The applicability of the switch device is not limited here to the above-mentioned examples. Thus the switch device can also find use with further functions that can be controlled via corresponding switches, and with other components of a vehicle.

Upon actuation the switch can provide an acoustic feedback to a user. Thus the switch can be arranged, for example, to generate during the actuation a clicking sound via suitable mechanical or electronic components. The switch can also be arranged to provide a suitable haptic feedback. Thus the switch can have a variable mechanical resistance during the pressing-down of the switch. Thus it can be indicated to a user acoustically or haptically whether and how far the switch has been actuated.

The switch can also define a certain actuation force that must be applied by a user in order to actuate the switch. Here the actuation force can fall in a range of 0.2 N to 8 N, in one example in a range of 1 N to 5 N, and in one example in a range of 2 N to 4 N. In the selection of the actuation force to be provided, the design of the lamination arrangement disposed over the switch, such as, for example, a layer thickness and a chosen material of the layers, can be taken into consideration. A switching threshold of the switch can be set by a suitable setting of the actuation force. The switch arrangement thus provides a simple and robust possibility for implementing a laminated switch in a vehicle. The switch can be configured removable from the lamination arrangement or fixedly integrated in the lamination arrangement.

In one example, the switch assembly includes no additional pulse generator or acoustic signal generator.

A haptic and acoustic feedback to the user can in one example be made possible solely by the switch provided in the switch assembly. For example, simple mechanical switches, for example, a “clicker”, can be used, since due to its construction it inherently provides a haptic and/or acoustic feedback of the switching process to the user. In contrast thereto, with many purely electrically or purely optically or capacitively operating switches according to the prior art, an additional pulse generator, for example, an electronic actuator, an unbalance motor, or a piezo element must be provided for the generating of a haptic feedback. In the prior art an additional acoustic signal generator, for example, a loudspeaker, must also be provided in order to provide an acoustic feedback. In addition, these additional electronic elements must be constantly correspondingly controlled in agreement with the switch, which uses an additional specific software. The present switch assembly thus provides a simple and cost-effective solution for laminated switches.

The present disclosure also relates to a method for the manufacturing of a lamination arrangement for the laminating of a switch in a vehicle, including the steps: providing at least one first layer that forms with its surface a visible side of the lamination arrangement; providing of a second layer that is disposed opposite the visible side at least partially under the first layer, in which the first and second layer are elastically deformable such that by exertion of force on the visible side, the actuation is made possible of at least one switch that can be disposed at least partially under the second layer.

The first and second layer can be disposed directly one-atop-the-other, i.e., in contact with each other. In other examples, one or more further layers can be provided between the first and the second layer. The first and second layer can also be at least partially spaced from each other. When a switch is to be actuated, the spaced layers can then be accordingly formed that they deform such that during exertion of force the first layer contacts the underlying second layer, in which the force exertion can then be transmitted to an underlying switch.

In one example the method further includes the step: providing at least one switch at least partially under the second layer.

The switch can be arranged such that it at least partially directly contacts the second layer. Or else the switch can be spaced from the second layer. Depending on the design of the second switch, for example, the layer thickness, the possible openings, and the arrangement of the switch, the switch can also protrude at least partially into the second layer.

The present disclosure additionally relates to a vehicle component comprising the lamination arrangement according to one of the preceding examples, or the switch assembly according one of the preceding examples.

In the present case, any component, for example, in the interior or exterior, of a vehicle is understood to be a “vehicle component.” In particular, such components are meant to which switches actuatable by a user are usually attached, which switches control one or more functions of the vehicle. Non-limiting examples thereof are components of a glove compartment, a seat heating, a door opener, and/or a start/stop device for the motor of the vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows in a schematic sectional view an exemplary switch assembly including a lamination arrangement according to the present disclosure; and

FIG. 2 shows in a schematic plan view an exemplary second layer according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

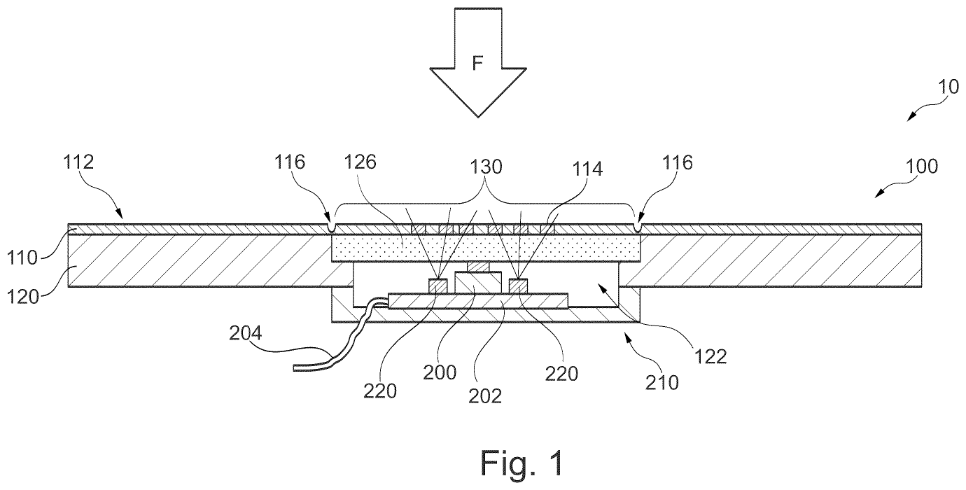

FIG. 1 shows in a schematic sectional view a switch assembly 10 comprising a lamination arrangement 100. The lamination arrangement 100 includes a plurality of layers, here in FIG. 1 by way of example two layers 110, 120. The upper layer shown in FIG. 1 is a first layer 110 that is elastically deformable and forms with it outwardly, in FIG. 1 upwardly, directed side or surface a continuous visible side 112 or visible layer of the lamination arrangement 100. The lower side shown in FIG. 1 is a second layer 120 that is also elastically deformable and is disposed opposite the visible layer or visible side 112, in FIG. 1 below the first layer 110. In the example depicted the lamination arrangement 100 is not yet deformed or deflected by external exertion of force onto the visible side 112. When a force F is exerted, for example, perpendicularly onto the visible side 112, in the example downward from above, the first layer 110 and the second layer 120 can be deformed downward and deflected (not shown). Of course the depicted layers 110, 120 can also be deformed downward and deflected with a force, that does not, as shown act perpendicularly downward from above, but rather, for example, also acts obliquely onto the visible side 112.

The first layer 110 defines a continuous outer decorative surface and includes a plurality of transparent regions 114 that extend through the layer and make possible a through-lighting from the underside. The lamination arrangement further includes a switch region 130. When a user presses the switch region 130 from above, it effects a deforming of the first and second layer 110, 120. These are correspondingly deflected downward by the exertion of force. Along the edge of the switch region 130, recesses 116 are provided in the first layer 110. These can make it easier for a user to recognize the switch region in the continuous decorative surface. In the region of the switch region 130 the second layer 120 includes an opening 122. Accordingly the layer thickness of the second layer 120 in this region is at least partially reduced. In the switch region 130 an at least partially transparent region 126 is provided that is part of the second layer 120. The transparent region 126 can comprise an at least partially transparent material that is identical to or different from the material of the rest of the layer 120. Alternatively or additionally the transparent region 126 can also include slots, perforations, or similar means that make possible a through-lighting of the transparent region 126. The switch 200 is disposed partially under the second layer 120. In the depicted example, in the rest state, i.e., without exertion of external force onto the visible side 112, the layer 120 contacts the underlying switch 200. When a user now presses from above onto the visible layer or visible side 112, i.e., exerts force, the first layer 110 and the second layer 120 disposed directly thereunder are deformed and deflected and press or actuate the underlying switch 200. In the depicted example the switch 200 is a mechanical switch that can be activated by pressing-down and can activate or deactivate a function of an associated component. The switch 200 is disposed on a circuit board 202, which in turn is received and supported by a carrier 210. Also disposed on the circuit board 202 are light sources 220, which make possible a through-lighting of the overlying layers 110, 120. Here the switch 200 and the light sources 220 can accordingly be supplied with current and controlled by the circuit board 202, which is supplied with current and controlled via a cable 204. The circuit board 202 is supported by the carrier 210, which is attached under the second layer 120. In the depicted example the carrier is configured in the shape of a housing that is attached from below onto the second layer 120.

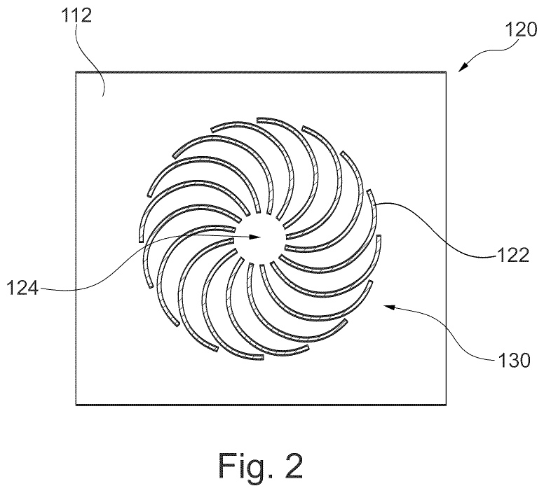

FIG. 2 shows a schematic view of an exemplary second layer 120 of the present disclosure. Here the second layer 120 includes spiral-shaped openings 122 in the form of perforations that form a weakening structure in the circular switch region 130. When a force F acts perpendicularly, here in the viewing direction, on the second layer 120, this region is more easily deformable than the surrounding region. In the center of the switch region 130 a reinforcement 124 is provided that provides no perforation, i.e., no corresponding weakening structure, and under which, for example, a switch 200 for the contacting can be provided.

The switch assembly 10 includes no additional pulse generator or acoustic signal generator.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A lamination arrangement for the laminating of a switch in a vehicle, the lamination arrangement comprising:
at least one first layer having a surface that forms a visible side of the lamination arrangement, and
at least one second layer disposed opposite the visible side and at least partially under the at least one first layer, the at least one first layer and the at least one second layer are elastically deformable such that an exertion of a force on the visible side of the at least one first layer is configured to actuate the switch.

2. The lamination arrangement according to claim 1, wherein at least one of the at least one first layer and the at least one second layer includes at least one switch region, and
wherein a deformability of at least one of the at least one first layer and the at least one second layer within the switch region is greater than outside the at least one switch region.

3. The lamination arrangement according to claim 2, wherein a layer thickness of at least one of the at least one first layer and the at least one second layer in the at least one switch region is less than outside the at least one switch region.

4. The lamination arrangement according to claim 2, wherein at least one of the at least one first layer and the at least one second layer includes at least one opening in the at least one switch region, and at least one of the at least one first layer and the at least one second layer is formed from a material that is different from a second material of the respective one of the at least one first layer and the at least one second layer outside the at least one switch region.

5. The lamination arrangement according to claim 2, wherein at least one of the at least one first layer and the at least one second layer is formed from a material that is different from a second material of the respective one of the at least one first layer and the at least one second layer outside the at least one switch region.

6. The lamination arrangement according to claim 1, further comprising a carrier disposed on the at least one second layer, and the carrier is configured to receive the switch such that the switch is disposed under the at least one second layer.

7. A switch assembly including the lamination arrangement according to claim 1, and a switch laminated by the lamination arrangement and disposed relative to the lamination arrangement, the switch is configured to be actuated by the exertion of the force on the visible side of the at least one first layer of the lamination arrangement.

8. The switch assembly according to claim 7, wherein the switch assembly includes no additional pulse generator or acoustic signal generator.

9. A vehicle component comprising the switch assembly according to claim 7.

10. A vehicle component comprising the lamination arrangement according to claim 1.

11. A method for manufacturing a laminating arrangement for laminating a switch in a vehicle, the method comprising:
providing at least one first layer having a surface that forms a visible layer of the laminating arrangement; and
disposing a second layer opposite the visible layer of the at least one first layer, the second layer at least partially disposed under the at least one first layer, the at least one first layer and the second layer are elastically deformable such that an exertion of a force on the visible layer is configured to actuate the switch.

12. The method of claim 11, further comprising coupling the switch at least partially under the second layer.
